(19) United States
(12) Patent Application Publication
(10) Pub. No.: US 2008/0018253 A1
(43) Pub. Date: Jan. 24, 2008

(54) Ultra-high-pressure mercury lamp

(75) Inventor: Hideyuki Matsumoto, Yokohama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM Gesellschft mit beschrankter, Munchen (DE)

(21) Appl. No.: 11/879,157

(22) Filed: Jul. 16, 2007

(30) Foreign Application Priority Data
Jul. 20, 2006 (JP) JP 2006-198052

(51) Int. Cl. H01J 61/073; H01J 61/84

(52) U.S. Cl. 313/631

(57) ABSTRACT

The aim is to provide an ultra-high-pressure mercury lamp in which the electrode gap is the virtually the same as conventional electrode gaps, but with which high illuminance can be achieved.

The ultra-high-pressure mercury lamp pertaining to the present invention comprises a light-emitting tube 1 at both ends of which a pair of electrodes 3a, 3b is positioned, and which contains mercury inside, in which ultra-high-pressure mercury lamp one of the electrodes of the pair 3a, 3b is caused to move a prescribed distance toward the bulb center 8a side of the light-emitting tube 1. Most preferably, the electrode gap is unchanged, and the point at which the brightness is greatest toward the center from the tip end of one of the electrodes is moved to the bulb center 8a.

### TECHNICAL FIELD

The present invention relates to an ultra-high-pressure mercury lamp which is used in a projector device. Said lamp comprises a light-emitting tube at both ends of which a pair of electrodes is arranged, and which contains mercury inside.

### BACKGROUND ART

With ultra-high-pressure mercury lamps (also referred to hereinafter as “lamp(s)”), narrowing the gap between the electrodes is an optically effective method in order to bring the lamp as close as possible to the point light source. However, with lamps with a narrow electrode gap, when the amount of mercury is increased in order to obtain the prescribed lamp characteristics, or when the electrode gap is changed due to the halogen cycle etc. during operation, the electrode gap at the terminals becomes narrower and the lamp characteristics may change markedly. See for example Japanese Unexamined Patent Application Publication 2005-285417.

### DISCLOSURE OF THE INVENTION

It is an object of the present invention to provide a an ultra-high-pressure mercury lamp which is usable in a projector device. Said lamp comprises a light-emitting tube at both ends of which a pair of electrodes is arranged, and which contains mercury inside. When the electrode gap of the lamp becomes narrower, the lamp voltage drops. When the lamp voltage drops, there are cases where the mercury pressure does not rise, and the electrical power of the lamp drops.

Furthermore, in a state in which the lamp voltage is low, it is necessary to increase the lamp electrical current in order to achieve prescribed electrical power for the lamp, but there are problems in that the lighting device for increasing the lamp electrical current becomes larger.

This object is achieved by the following features:

at least one of the electrodes of the abovementioned pair of electrodes is able to move a certain distance toward the bulb center side of the abovementioned light-emitting tube.

Particularly advantageous configurations are given in the dependent claims.

The present invention is a device to resolve the problems described above, and it involves an electrode gap that is virtually the same as conventional electrode gaps, but it aims to provide an ultra-high-pressure mercury lamp with which high illuminance can be achieved.

The ultra-high-pressure mercury lamp pertaining to the present invention comprises a light-emitting tube at both ends of which a pair of electrodes is positioned, and which contains mercury inside, which ultra-high-pressure mercury lamp is characterized in that one of the electrodes of the pair is caused to move a prescribed distance toward the bulb center side of the light-emitting tube.

Furthermore, the ultra-high-pressure mercury lamp pertaining to the present invention is characterized in that the other electrode of the pair is caused to move a prescribed distance so that the distance between the pair of electrodes does not change.

The ultra-high-pressure mercury lamp pertaining to the present invention has an electrode gap virtually the same as conventional electrode gaps, but it can achieve high illuminance.

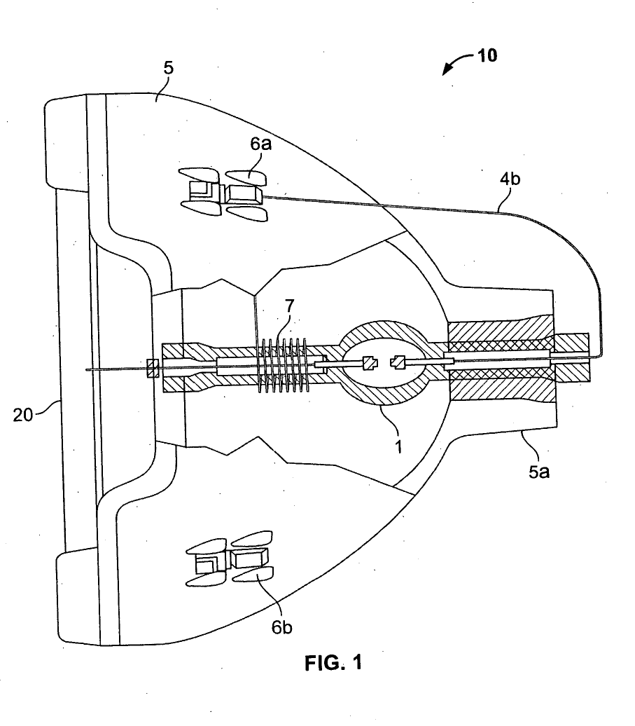

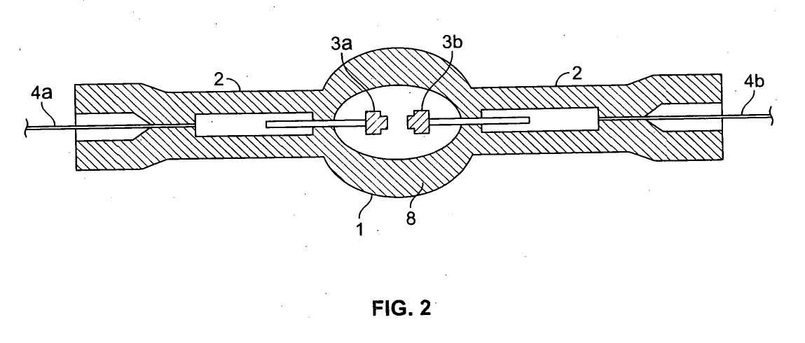

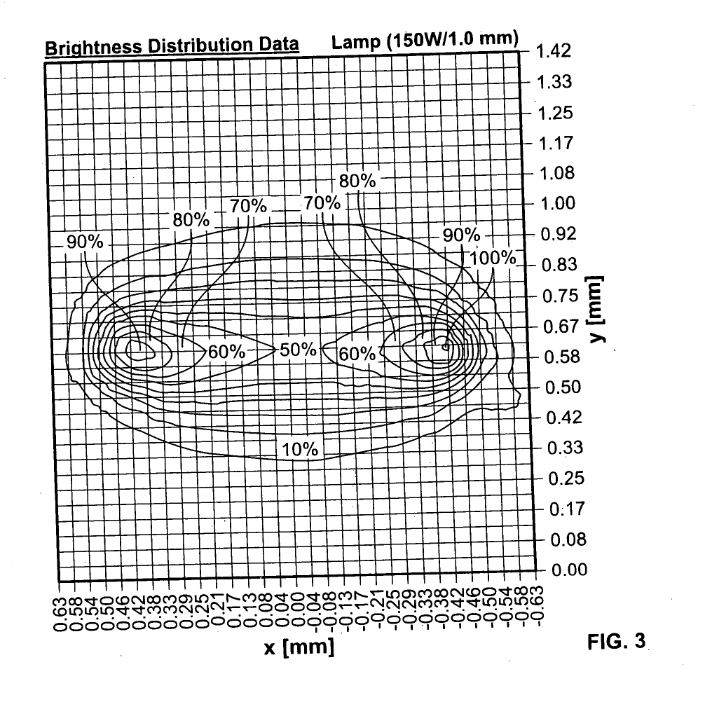

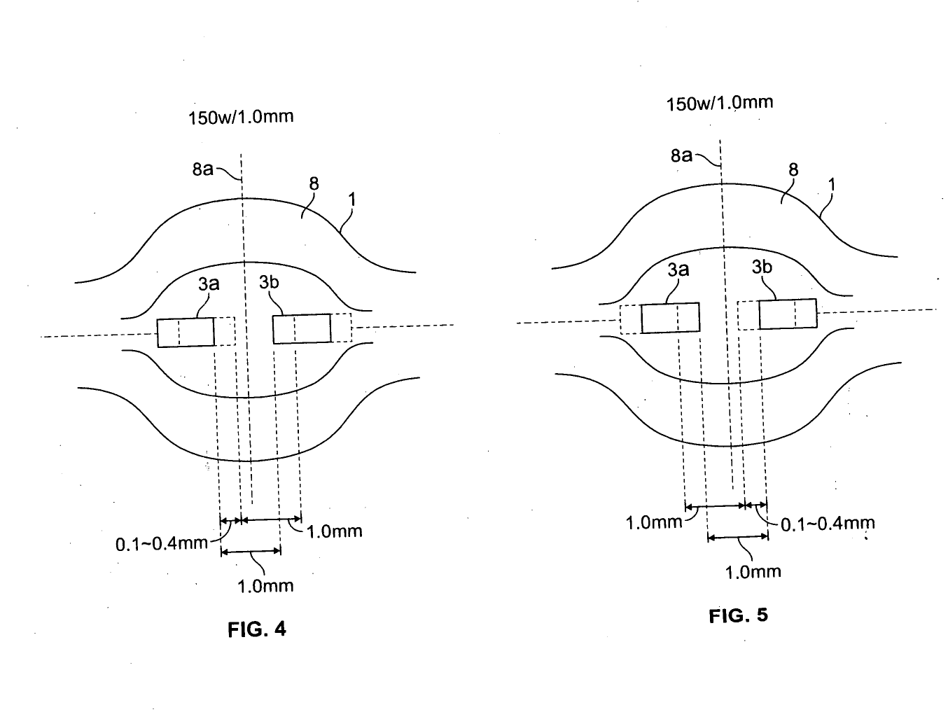

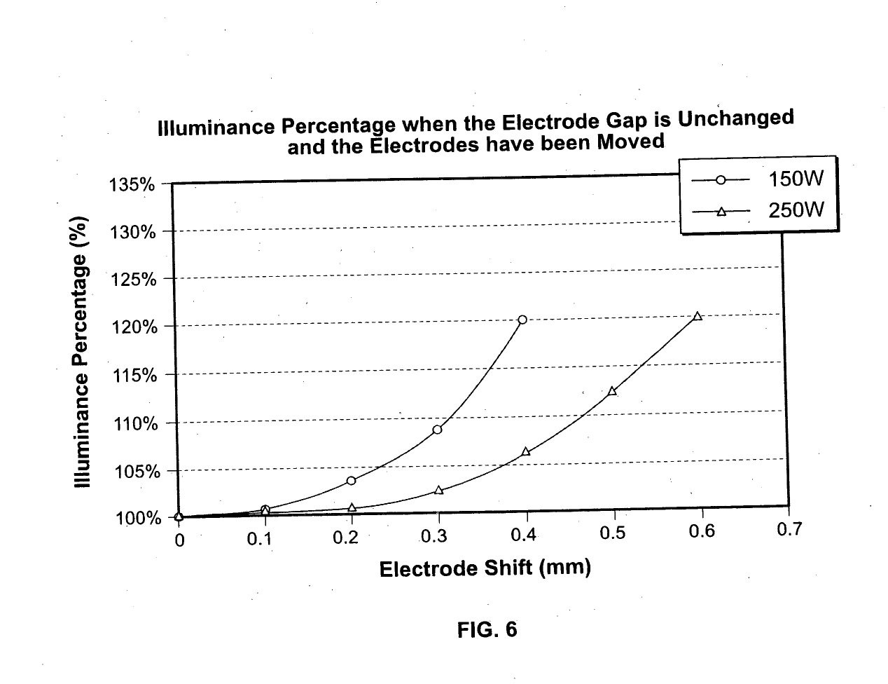

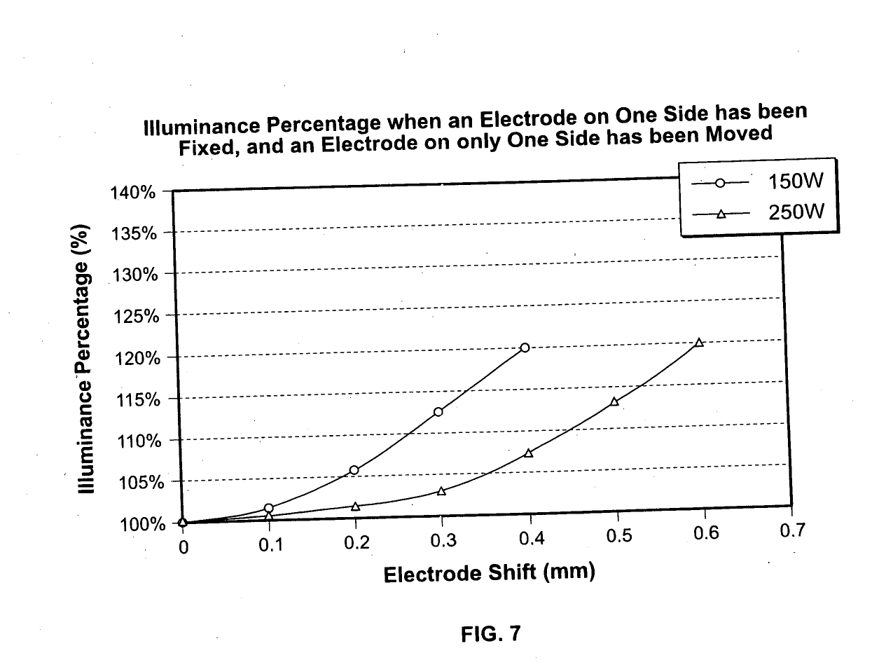

### BRIEF DESCRIPTION OF THE DRAWINGS

[FIG. 1] shows mode of embodiment 1, and it is a side surface view in partial section of the ultra-high-pressure mercury lamp 10;

[FIG. 2] shows mode of embodiment 1, and it is a cross-sectional view of the light-emitting tube 1;

[FIG. 3] shows mode of embodiment 1, and it shows brightness distribution data for the ultra-high-pressure mercury lamp 10 (150 W/1.0 mm (electrode gap));

[FIG. 4] shows mode of embodiment 1, and it is a plan view of the light-emitting tube 1;

[FIG. 5] shows mode of embodiment 1, and it is a plan view of the light-emitting tube 1;

[FIG. 6] shows mode of embodiment 1, and it shows the illuminance percentage when the electrode gap is unchanged and the electrodes have been moved; and

[FIG. 7] shows mode of embodiment 1, and it shows the illuminance percentage when an electrode on one side has been fixed, and an electrode on only one side has been moved.

### BEST MODE FOR CARRYING OUT THE INVENTION

### Mode of Embodiment 1

FIGS. 1 to 7 show mode of embodiment 1, where FIG. 1 is a side surface view in partial section of an ultra-high-pressure mercury lamp 10; FIG. 2 is a cross-sectional view of a light-emitting tube 1; FIG. 3 shows brightness distribution data for the ultra-high-pressure mercury lamp 10 (150 W/1.0 mm (electrode gap)); FIG. 4 and FIG. 5 are plan views of the light-emitting tube 1; FIG. 6 shows the illuminance percentage when the electrode gap is unchanged and the electrodes have been moved; and FIG. 7 shows the illuminance percentage when an electrode on one side has been fixed, and an electrode on only one side has been moved.

As shown in FIG. 1, in the ultra-high-pressure mercury lamp 10, the light-emitting tube 1 is fixed in the neck part 5a of a reflector 5 (concave reflective mirror) which comprises an open part 20 for the forward output of light, so that the optical axes match. A terminal 6a and a terminal 6b which are connected by a lead wire 4b from the electrode of the light-emitting tube 1 are arranged on the outer peripheral surface of the reflector 5. A trigger coil 7 is provided on the light-emitting tube 1 for causing the activation of the light-emitting tube 1.

As shown in FIG. 2, the light-emitting tube 1 comprises a bulb 8 made of quartz glass and a sealing part 2 formed along both sides of said bulb 8. The inside of the bulb 8 contains mercury, and part of the electrode 3a and the electrode 3b is sealed by the sealing part 2. A lead wire 4a and the lead wire 4b extend from the sealing part 2.

FIG. 3 shows brightness distribution data for the ultra-high-pressure mercury lamp (150 W/1.0 mm (electrode gap)). The X-axis shows the distance x (mm) in a straight line which links the pair of electrodes, taking the bulb center as 0, with the left side as + and the right side as −. The Y-axis is the distance y (mm) in the direction orthogonal to the straight line which links the pair of electrodes. The brightness values are relative, taking 100 as the maximum brightness.

As shown in FIG. 3, the position at which the brightness of the light-emitting tube 1 in the ultra-high-pressure mercury lamp 10 (150 W/1.0 mm (electrode gap)) is highest is not at the tip end of the electrode 3a and the electrode 3b, but several mm from the tip end of the electrode 3a and the electrode 3b toward the center. When the bulb center is taken as 0, this is the point +0.4167, 0.0833 mm from the tip end of the electrode toward the center on the left hand side of FIG. 3. This is the point −0.4167, 0.0833 mm from the tip end of the electrode toward the center on the right hand side of FIG. 3.

The light-emitting tube 1 is provided with the electrode 3a and the electrode 3b inside the bulb 8. The electrode 3a and the electrode 3b are normally arranged symmetrical to the bulb center 8a (solid line), but in this mode of embodiment, as shown by the broken line in FIG. 4, the electrode 3a and the electrode 3b are moved 0.1-0.4 mm to the right, for example. By virtue of this, if the electrodes are moved 0.4 mm, for example, the portion of highest brightness on the left hand side lies almost in the vicinity of the bulb center 8a, and it can be expected that the illuminance of the light radiated from the open part 20 of the ultra-high-pressure mercury lamp 10 will increase. Furthermore, since the electrode 3a and the electrode 3b are moved with each other, the electrode gap stays at 1.0 mm, and therefore it is thought that there is little risk that the mercury pressure will fail to rise and that the electrical power of the lamp will drop because of a drop in the lamp voltage.

Furthermore, as shown in FIG. 5, the electrode 3a and the electrode 3b may be moved 0.42 mm to the left, for example. By virtue of this, the portion of highest brightness on the right hand side lies almost in the vicinity of the bulb center 8a, and it can be expected that the illuminance of the light radiated from the open part 20 of the ultra-high-pressure mercury lamp 10 will increase. In the same way as in FIG. 4, since the electrode 3a and the electrode 3b are moved with each other, the electrode gap stays at 1.0 mm, and therefore it is also thought that there is no risk that the mercury pressure will fail to rise and that the electrical power of the lamp will drop because of a drop in the lamp voltage.

FIG. 6 shows the results obtained from a simulation of the illuminance of the ultra-high-pressure mercury lamp 10 (150 W/1.0 mm) having the configuration shown in FIGS. 4 and 5. FIG. 6 also shows the results using an ultra-high-pressure lamp 10 (250 W/1.3 mm). In FIG. 6, the X-axis shows the electrode shift (electrode movement distance, units: mm), and the Y-axis shows relative illuminance values, taking the illuminance (illuminance on a 40 inch projector screen) when the electrode 3a and the electrode 3b are not moved as 100. Furthermore, the illuminance percentage is the average value of the illuminance when the electrode 3a and the electrode 3b are moved to the left and when they are moved to the right.

In the case of the ultra-high-pressure mercury lamp 10 (150 W/1.0 mm), when the electrode gap is unchanged and the electrode 3a and the electrode 3b are moved with each other by 0.1 mm, the illuminance increases by approximately 0.3%. Furthermore, in the same way, when the electrode 3a and the electrode 3b are moved with each other by 0.2 mm, the illuminance increases by approximately 5%. Furthermore, in the same way, when the electrode 3a and the electrode 3b are moved with each other by 0.3 mm, the illuminance increases by approximately 10%. Furthermore, in the same way, when the electrode 3a and the electrode 3b are moved with each other by 0.4 mm, the illuminance increases by approximately 20%.

In the case of the ultra-high-pressure mercury lamp 10 (250 W/1.3 mm), when the electrode gap is unchanged and the electrode 3a and the electrode 3b are moved with each other by 0.1 mm, the illuminance increases by approximately 0.2%. Furthermore, in the same way, when the electrode 3a and the electrode 3b are moved with each other by 0.2 mm, the illuminance increases by approximately 1.3%. Furthermore, in the same way, when the electrode 3a and the electrode 3b are moved with each other by 0.3 mm, the illuminance increases by approximately 3.5%. Furthermore, in the same way, when the electrode 3a and the electrode 3b are moved with each other by 0.4 mm, the illuminance increases by approximately 8%. Furthermore, in the same way, when the electrode 3a and the electrode 3b are moved with each other by 0.5 mm, the illuminance increases by approximately 13%. Furthermore, in the same way, when the electrode 3a and the electrode 3b are moved with each other by 0.6 mm, the illuminance increases by approximately 20%.

FIG. 7 shows the illuminance percentage when an electrode is fixed on one side, and an electrode on only one side has been moved. As shown in FIG. 7, in this case also, results virtually the same as those for FIG. 6 have been obtained. Accordingly, the illuminance of the light radiated from the open part 20 of the ultra-high-pressure mercury lamp 10 can be increased, even if an electrode is fixed on one side and an electrode on only one side is moved, within the range where the mercury pressure does not rise and the electrical power of the lamp does not drop because of a drop in the lamp voltage.

As can be seen from the above, it is possible to increase the illuminance of the light radiated from the open part 20 of the ultra-high-pressure mercury lamp 10 by bringing one electrode of the ultra-high-pressure mercury lamp 10 closer to the bulb center 8a or by making it conform therewith. In this case, the other electrode may be moved in the same manner as the first electrode so that the electrode gap does not change, or it may be fixed. However, if the electrode gap becomes smaller, the mercury pressure may not rise and the electrical power of the lamp may drop because of a drop in the lamp voltage, and therefore it is preferable for the electrode gap not to change too much.

What is claimed is:

1. An ultra-high-pressure mercury lamp comprising a light-emitting tube at both ends of which a pair of electrodes is arranged, and which contains mercury inside, wherein at least one of the electrodes of the above-mentioned pair of electrodes is able to move a certain distance toward the bulb center side of the abovementioned light-emitting tube.

2. The ultra-high-pressure mercury lamp as claimed in claim 1, wherein the second electrode of the abovementioned pair is also able to move a distance.

3. The ultra-high-pressure mercury lamp as claimed in claim 2, wherein both electrodes of the abovementioned pair are moved the same distance so that the distance between the abovementioned pair of electrodes does not change.
